(19) United States
(12) Patent Application Publication
(10) Pub. No.: US 2024/0152926 A1
(43) Pub. Date: May 9, 2024

(54) PREVENTING DIGITAL FRAUD UTILIZING A FRAUD RISK TIERING SYSTEM FOR INITIAL AND ONGOING ASSESSMENT OF RISK

(71) Applicant: Chime Financial, Inc., San Francisco, CA (US)

(72) Inventors: SaiLohith Musunuru, Chicago, IL (US); Ilan Israel Zimmer, San Jose, CA (US)

(21) Appl. No.: 18/052,423

(22) Filed: Nov. 3, 2022

(51) Int. Cl. G06Q 20/40

(52) U.S. Cl. CPC G06Q 20/4016

(57) ABSTRACT

The present disclosure relates to systems, non-transitory computer-readable media, and methods for managing fraud-risk in digital networks utilizing an intelligently trained fraud-risk tiering system. In particular, in one or more embodiments, the disclosed systems utilize one or more fraud-risk tiering models to determine an initial risk tier for a digital account from a plurality of risk tiers based on attributes received upon creation of the digital account. Further, in one or more embodiments, the disclosed systems utilize one or more fraud-risk tiering models to determine an updated risk tier for the digital account further based on account usage data. In some embodiments, the disclosed systems utilize one or more machine learning models for initial and ongoing fraud-risk assessment of digital accounts.

### BACKGROUND

As online transactions have increased in recent years, network-transaction-security systems have increasingly used computational models to detect and protect against cyber fraud, cyber theft, or other network security threats that compromise encrypted or otherwise sensitive information. For example, as network security risks have increased, existing network-transaction-security systems have employed more sophisticated computing models to detect security risks affecting transactions, account balances, personal identity information, and other information over computer networks that user computing device applications. In mobile network financial applications, such as mobile systems providing peer-to-peer (P2P) payment capabilities, for instance, these security risks can take the form of synthetic digital accounts, identity theft, deposits of fraudulent checks, and so forth. Exacerbating these issues, hackers have become more sophisticated—in some cases to the point of mimicking the characteristics of authentic digital accounts or transactions detected or flagged by existing computational methods.

In view of the foregoing complexities, conventional network-transaction-security systems have proven inaccurate—often failing to detect fraudulent accounts or transactions until too late. Indeed, conventional network-transaction-security systems often fail to intelligently designate accounts at an accurate level of risk for fraud when making decisions for account authorizations, incentives, or restrictions. For instance, because hackers try to simulate the features of an authorized or legitimate account, computing systems that apply rigid evaluation models upon account creation often fail to identify risks for fraudulent activity within aging accounts. Without more sophisticated and ongoing fraud-risk identification capabilities, conventional network-transaction-security systems perpetuate inaccuracies of fraud-risk identification, thus permitting otherwise avoidable instances of fraudulent activity.

These along with additional problems and issues exist with regard to conventional network-transaction-security systems.

### BRIEF SUMMARY

This disclosure describes one or more embodiments of systems, non-transitory computer-readable media, and methods that solve one or more of the foregoing or other problems in the art or provide other benefits. In particular, the disclosed systems utilize an intelligently trained fraud-risk tiering system to continuously predict whether a digital account on a digital financial network is fraudulent or likely to perpetuate or attempt fraudulent activity on the digital financial network. For example, the disclosed systems assign weighted values to user, account, and device attribute data received from various sources to segment user accounts into multiple fraud-risk tiers. For instance, in some implementations, a low-risk tier corresponds to a majority of user accounts, which are expected to exhibit a low fraud rate compared to those accounts corresponding to a high-risk tier, which are expected to have a significantly higher fraud rate.

By utilizing an intelligently trained fraud-risk tiering system to continuously evaluate user accounts for risk of fraud, the disclosed systems can improve the accuracy of detecting or predicting fraudulent accounts and/or account activity. As further described below, the disclosed systems can accordingly improve the speed and computing efficiency of detecting fraudulent accounts and/or risk of fraudulent activity over existing network-transaction-security systems. In some cases, the disclosed systems can detect and prevent cyber fraud that existing network-transaction-security systems cannot preemptively identify.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a fraud-risk tiering system can operate in accordance with one or more embodiments.

FIG. 2 illustrates a fraud-risk tiering system utilizing weighted account attributes to determine risk tiers for a digital account in accordance with one or more embodiments.

FIG. 3 illustrates a fraud-risk tiering system utilizing fraud-risk models to determine an account risk tier in accordance with one or more embodiments.

FIG. 4 illustrates a fraud-risk tiering system training a fraud-risk model to determine risk tiers in accordance with one or more embodiments.

FIG. 5 illustrates a fraud-risk tiering system performing ongoing assessment of fraud risk for a digital account in accordance with one or more embodiments.

FIG. 6 illustrates a flowchart of a series of acts for utilizing a fraud-risk tiering system to continuously assess fraud risk in accordance with one or more embodiments.

FIG. 7 illustrates a block diagram of an example computing device for implementing one or more embodiments of the present disclosure.

FIG. 8 illustrates an example environment for a fraud-risk tiering system in accordance with one or more embodiments.

### DETAILED DESCRIPTION

This disclosure describes one or more embodiments of a fraud-risk tiering system that utilizes one or more intelligently trained fraud-risk tiering models to predict, detect, and avoid fraudulent activity within a digital financial network. For example, the fraud-risk tiering system can be trained by monitoring and testing model inputs and outputs with respect to a sample population of user accounts. Model inputs can include various attributes derived from data provided by a variety of sources, such as user enrollment information provided by the user upon account creation, device data pulled from the user computing device, account usage data gathered for each sample account, and/or additional metrics.

Thus, utilizing a rules-based feature set, in some embodiments, the fraud-risk tiering system can divide a member (i.e., user/account) population into a plurality of fraud-risk tiers indicating whether each member may present a risk of committing fraud against the system or outside of the system using the respective member account. For instance, in some implementations, a low-risk tier may correspond to most accounts within the population, which are expected to exhibit a low rate of fraud compared to the overall population. A high-risk tier may correspond to a relatively small segment of the population, which are expected to exhibit a significantly higher fraud rate than those of the low-risk tier. Additional risk tiers can also be developed according to one or more of the disclosed embodiments to segment a member population.

In some embodiments, the fraud-risk tiering system can receive a request from a user computing device to create a digital account on a digital financial network, the request including user enrollment information and device data corresponding to the user computing device. In response to receiving the request, the disclosed systems can create the digital account and determine an initial risk tier for the digital account from a plurality of risk tiers based on attributes corresponding to the user enrollment data and the device data. Furthermore, in response to identifying account usage data corresponding to the digital account, the disclosed systems can determine an updated risk tier for the digital account based on the identified account usage data. Thus, in certain embodiments, the disclosed systems enable fraud-risk analysis of accounts from account creation and on an ongoing basis utilizing various data sources, as well as third-party integrations.

The fraud-risk tiering system provides many advantages and benefits over conventional systems and methods. For example, by utilizing an intelligently trained fraud-risk tiering model to evaluate accounts, the fraud-risk tiering system improves accuracy relative to conventional systems. Specifically, in certain embodiments, the fraud-risk tiering system implements one or more fraud-risk tiering models that are intelligently trained utilizing known population data to accurately sort new and ongoing accounts into risk tiers that accurately represent each account's likelihood of perpetuating fraud or other forms of undesirable behavior. In certain cases, the fraud-risk tiering system identifies (and uses) user enrollment data and device data that have proven better attributes than others in accurately predicting whether a new or ongoing account poses a security risk, such as by comparing a user address from user enrollment data with a geospatial location from the device data. In some such cases, the difference between a provided physical address and a geospatial location is weighted more heavily and improves real-time risk tiering. Tables 1 and 2 below further illustrate the impact of better attributes. By continuing to determine an initial risk tier and then an updated risk tier at different events or timeframes, the fraud-risk tiering system can accurately determine security risk on the fly and avoid certain cyber fraud, cyber theft, and other network security risks that plague conventional network-transaction-security systems.

Furthermore, by utilizing intelligently trained fraud-risk tiering models at account creation and on an ongoing basis, the fraud-risk tiering system improves efficiency relative to conventional network-transaction-security systems. In particular, in certain embodiments, the fraud-risk tiering system efficiently and effectively evaluates accounts for fraud-risk and thereby enable intelligently-educated decisions with respect to account authorizations, such as access to mobile application features and/or incentive based on assigned risk tiers.

As suggested above, some existing network-transaction-security systems use a basic heuristic computing model that identify or evaluate risk of a digital account facilitating fraudulent activity or a cyber security threat only after a series of fraudulent claims or other security-compromising activities have been submitted by the digital account or linked digital account based on thresholds for a cumulative amount and number of claims. In such cases, the existing network-transaction-security systems must inefficiently use memory and processing to track and process an entire series of claims or other security-compromising activities, sometimes requiring a re-run of the basic heuristic model on claims from a digital account as new claims from the same digital account are submitted. By contrast, the fraud-risk tiering system can detect digital accounts that pose a fraud or cyber security risk early in a digital account's lifetime based on user enrollment data, device data, and/or account usage data rather than after a series of fraudulent claims or other security-compromising activities detected over a longer time by a heuristic computational model. Rather than inefficiently run and re-run a heuristic computational model for activity after a long series of activity has been performed, the fraud-risk tiering system can determine (and update) a risk tier at initial opening of a digital account and as each usage adds to account usage data- and dynamically activate or deactivate features on an application for the digital account based on the determined risk tier-thereby preserving computing resources inefficiently expended by existing heuristic computational models.

Moreover, by training fraud-risk tiering models and considering various types and sources of data to evaluate and sort accounts, the fraud-risk tiering system exhibits increased flexibility relative to conventional systems. For instance, in certain embodiments, the fraud-risk tiering system can be implemented utilizing virtually any available data to intelligently sort accounts into fraud-risk tiers. Also, the disclosed embodiments can be implemented in a variety of environments, such as but not limited to a variety of financial networks, information databases, online members-only associations, and so forth.

As illustrated by the foregoing discussion, the present disclosure utilizes a variety of terms to describe features and advantages of the fraud-risk tiering system. Additional detail is now provided regarding the meaning of such terms. For example, as used herein, the term “digital account” refers to a computer environment or location with personalized digital access to a web application, a native application installed on a client device (e.g., a mobile application, a desktop application, a plug-in application, etc.), or a cloud-based application. In particular embodiments, a digital account includes a financial payment account through which a user can initiate a network transaction (e.g., an electronic payment for goods or services) on a client device or with which another user can exchange tokens, currency, or data. Examples of a digital account include a CHIME® account. In addition, a “recipient account” refers to a digital account designated to receive funds, tokens, currency, or data in a network transaction.

Relatedly, as used herein, the term “network transaction” refers to a transaction performed as part of a digital exchange of funds, tokens, currency, or data between accounts or other connections of a computing system. In particular embodiments, the network transaction can be a mobile check deposit (e.g., a digital request for executing a check that can transfer funds from a check maker account to a recipient account), a direct deposit of a paycheck, a peer-to-peer (P2P) transfer of funds (e.g., a digital request for executing a direct transfer of funds from a financial account of a requesting user to a financial account of associated with another user), a purchase by credit or debit, a withdrawal of cash, and so forth. Indeed, a network transaction can be implemented via a variety of client devices. In some embodiments, the network transaction may be a transaction with a merchant (e.g., a purchase transaction) in which a merchant or payee indicated on a transaction request corresponds to the recipient account.

As also used herein, the term “attribute” refers to characteristics or features related to a network transaction or a digital account. In particular embodiments, an attribute includes account-based characteristics associated with an account holder (i.e., user) and/or a computing device associated with the digital account and/or the account holder (e.g., a user computing device utilized to request/create the digital account and/or to perform network transactions).

As used herein, the term “fraud-risk model” refers to a model trained or used to identify illegitimate digital accounts and/or illegitimate network transactions. For example, in some embodiments, a fraud-risk model refers to a statistically trained tiering scheme for identifying risk of fraud among a large population of accounts. In some cases, a fraud-risk model can include a machine learning model, such as but not limited to a random forest model, a series of gradient boosted decision trees (e.g., XGBoost algorithm), a multilayer perceptron, a linear regression, a support vector machine, a deep tabular learning architecture, a deep learning transformer (e.g., self-attention-based-tabular transformer), or a logistic regression. In other embodiments, a fraud-risk machine learning model includes a neural network, such as a convolutional neural network, a recurrent neural network (e.g., an LSTM), a graph neural network, a self-attention transformer neural network, or a generative adversarial neural network.

As used herein, the term “risk tier” refers to a level or grade within a fraud-risk hierarchy developed to sort digital accounts and/or users according to a historical probability of security incidents, such as but not limited to identity fraud, transaction fraud, debt delinquency, and so forth. For example, in some cases, a low-risk tier is determined based on historical data to represent a majority portion of a population of accounts/users, the majority portion exhibiting a relatively small number of occurrences of security incidents. Accordingly, a high-risk tier may represent a relatively small portion of the same population, the relatively small portion exhibiting an elevated number of security occurrences.

As used herein, the term “user enrollment data” refers to information associated with a user's creation of a new digital account. For instance, in one or more embodiments, user enrollment data includes information provided by a user in response to questions presented to the user in response to the user's request to create a new digital account. In some embodiments, for example, user enrollment data includes a user's physical address, email address, phone number, IP address and/or geospatial location at time of enrollment, birth date, other personal identification information, and so forth. Additionally or alternatively, in some embodiments, user enrollment data includes information provided by a third-party identity verification platform and/or other onboarding services.

As used herein, the term “device data” refers to information associated with one or more client devices associated with a user of a digital account. For instance, in one or more embodiments, device data includes information associated with a client device (e.g., a personal computer or mobile phone) utilized to enroll/create and/or access a digital account. In some embodiments, for example, device data includes a number of devices used to access a digital account, a number of closed or otherwise invalid digital accounts associated with a device, a number of unique digital accounts associated with a device, a location history (e.g., time zones) of a device when accessing a digital account, and so forth. Additionally or alternatively, in some embodiments, device data includes information provided by a third-party platform, such as a customer data platform (CDP).

As used herein, the term “account usage data” refers to information associated with usage, historical and ongoing, of a digital account. For instance, in one or more embodiments, account usage data can include a record of user interactions with a digital account, such as but not limited to login history, interaction with other accounts and third-party services via the digital account, security events, and so forth.

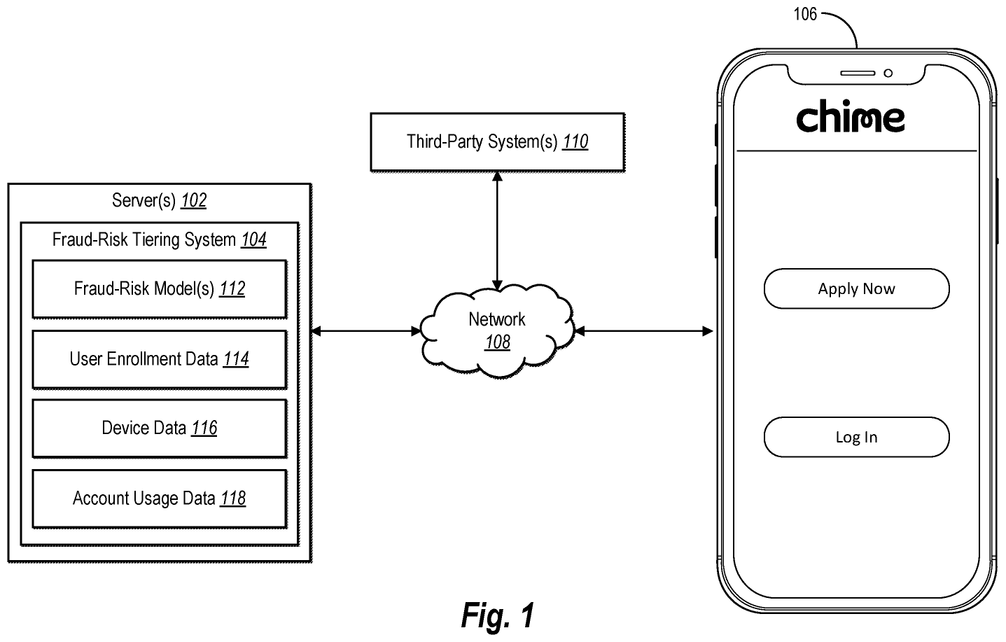

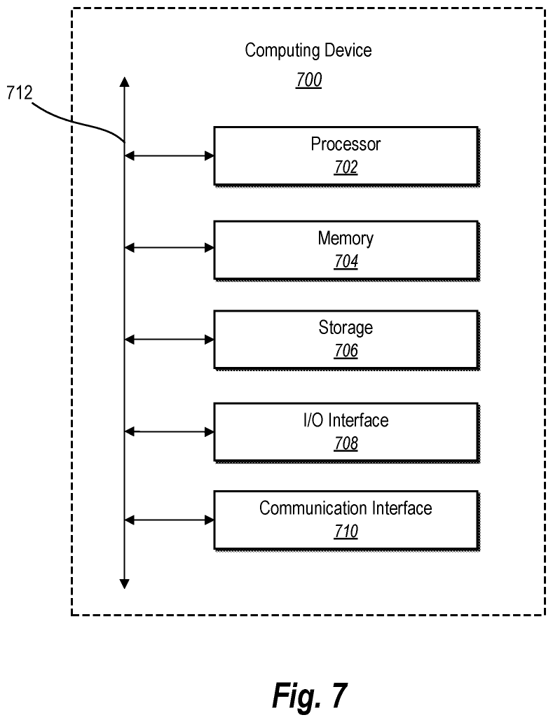

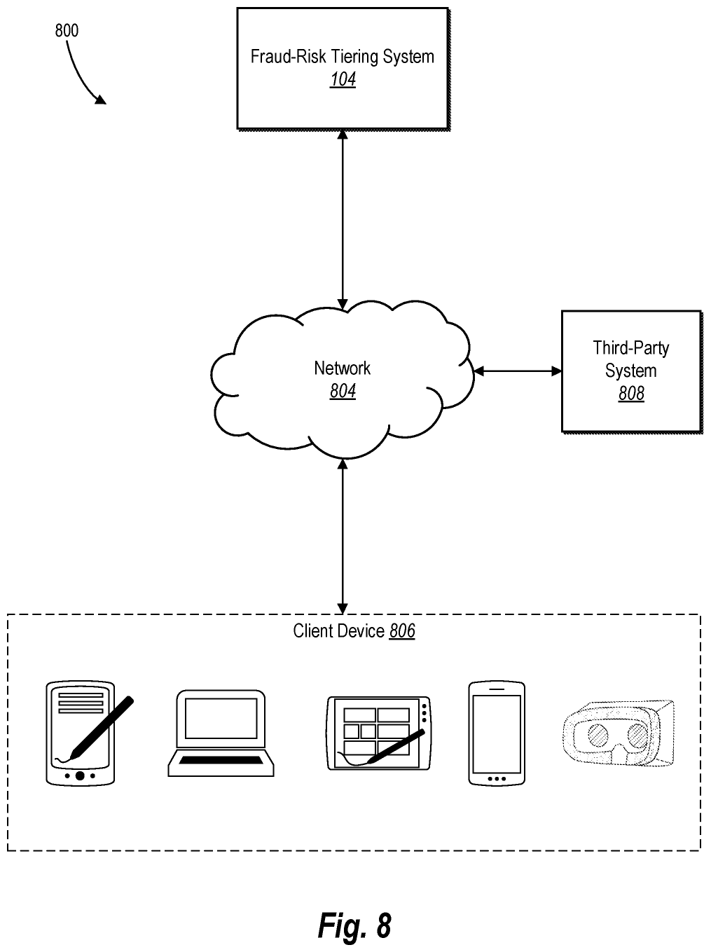

Additional detail regarding the fraud-risk tiering system will now be provided with reference to the figures. In particular, FIG. 1 illustrates a computing system environment for implementing a fraud-risk tiering system 104 in accordance with one or more embodiments. As shown in FIG. 1, the environment includes server(s) 102, client device 106, a network 108, and one or more third-party system(s) 110. In some embodiments, the environment includes additional systems connected to the fraud-risk tiering system 104, such as a credit processing system, an ATM system, or a merchant card processing system. The server(s) 102 can include one or more computing devices (and a database) to implement the fraud-risk tiering system 104. Additional description regarding the illustrated computing devices (e.g., the server(s) 102, the client device 106, and/or the third-party system(s) 110) is provided below in relation to FIGS. 7-8.

As shown in FIG. 1, the fraud-risk tiering system 104 utilizes the network 108 to communicate with the client device 106 and/or the third-party system(s) 110. The network 108 may comprise any network described in relation to FIGS. 7-8 below. For example, the server(s) 102 communicates with the client device 106 to provide and receive information pertaining to user accounts, financial transactions, account balances, funds transfers, or other information. Starting at account creation, the fraud-risk tiering system 104 utilizes one or more fraud-risk model(s) 112 to determine a risk tier for an account initialized by the client device 106 and continuously updates the risk tier of the account on an ongoing basis as further discussed below.

As illustrated, the fraud-risk tiering system 104 evaluates data from various sources to determine risk tiers for each respective account, such as user enrollment data 114 received, for example, from the client device 106 upon account creation. Additional inputs to the fraud-risk tiering model include, but are not limited to, device data 116 corresponding to the client device 106 associated with each respective account and account usage data 118, such as but not limited to transaction history, payment history, account verification events, and so forth.

As indicated by FIG. 1, the client device 106 includes a client application. In many embodiments, the fraud-risk tiering system 104 communicates with the client device 106 through the client application to, for example, receive and provide information including attribute data pertaining to user actions for logins, account registrations, credit requests, transaction disputes, or online payments (or other client device information), as well as the user enrollment data 114 and device data 116 pertaining to client device 106. In addition, the fraud-risk tiering system 104 can receive information from one or more third-party system(s) 110, such as third-party providers of security evaluation and/or background information.

As indicated above, the fraud-risk tiering system 104 can provide (and/or cause the client device 106 to display or render) visual elements within a graphical user interface associated with the client application. For example, the fraud-risk tiering system 104 can provide a graphical user interface that includes a login screen and/or an option to request/create a new account. In some cases, the fraud-risk tiering system 104 provides user interface information for a user interface for performing various user actions, such as but not limited to a credit request, a transaction dispute, an online payment towards an outstanding balance, a mobile deposit, or a peer-to-peer (P2P) transfer of funds. As described in greater detail below, in some embodiments, the fraud-risk tiering system 104 activates and/or deactivates various mobile application features (and/or incentives) based on respectively assigned risk tiers as determined utilizing the fraud-risk model(s) 112.

Although FIG. 1 illustrates the environment having a particular number and arrangement of components associated with the fraud-risk tiering system 104, in some embodiments, the environment may include more or fewer components with varying configurations. For example, in some embodiments, the fraud-risk tiering system 104 can communicate directly with the client device 106 and/or the third-party system(s) 110, bypassing the network 108. Further, the fraud-risk tiering system 104 can include more network components communicatively coupled together.

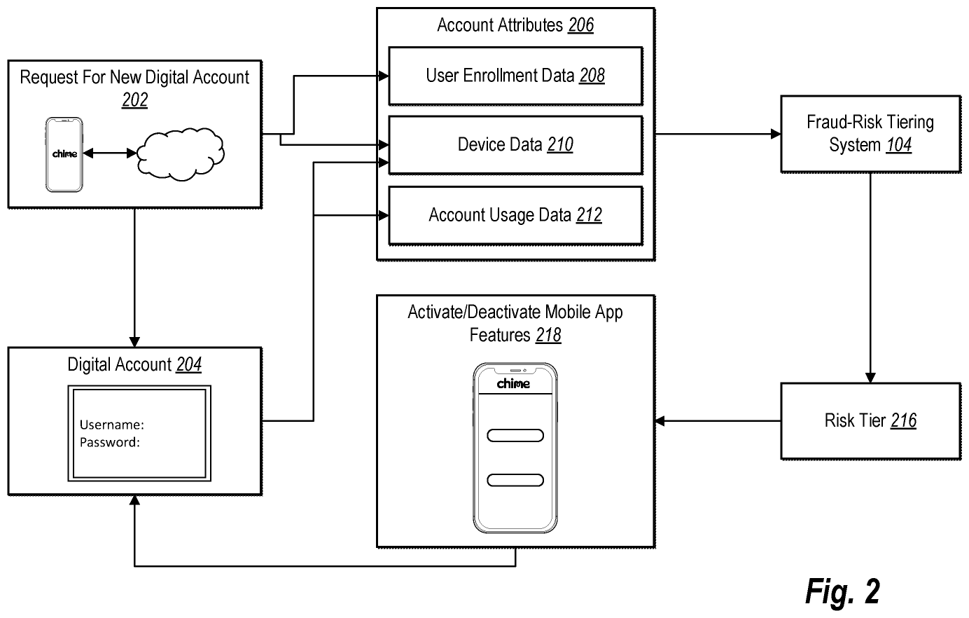

As discussed above, the fraud-risk tiering system 104 can monitor and determine a risk tier for digital accounts on an ongoing basis. For instance, FIG. 2 illustrates the fraud-risk tiering system 104 utilizing various types of data to assign and/or update a risk tier 216 for a digital account 204 in accordance with one or more embodiments. Specifically, FIG. 2 shows the fraud-risk tiering system 104 receiving a request 202 for a new digital account. Upon receipt of the request 202, the fraud-risk tiering system 104 receives and considers various account attributes 206 to determine an accurate or appropriate risk tier as the risk tier 216 for the digital account 204 that has been requested to be created as a new digital account. Thereafter, the fraud-risk tiering system 104 continues to evaluate the account attributes 206 to ensure that the risk tier 216 is accurately assigned for the digital account 204.

In particular, as shown in FIG. 2, the fraud-risk tiering system 104 analyzes the request 202 to initially assign the risk tier 216 for the digital account 204 based at least on user enrollment data 208, which is generally provided by the user as part of the request 202 (e.g., in response to a survey of questions provided to the user), and device data 210, which can be sourced directly from the user's device or otherwise provides by another service. Accordingly, the fraud-risk tiering system 104 determines the risk tier 216 as an initial risk tier for the digital account 204 that has been newly created. In some cases, as an initial risk tier, the risk tier 216 can indicate to the digital security system that the requested account should not be created (e.g., due to a level of fraud-risk that exceeds a predetermined threshold value).

As further illustrated in FIG. 2, the fraud-risk tiering system 104 continues to receive and evaluate the account attributes 206 to re-determine (or update) the risk tier 216 for the digital account 204. For instance, as the fraud-risk tiering system 104 receives account usage data 212 and may receive additional device data as part of the device data 210. The account usage data 212, for example, can include transactions (e.g., purchases and/or payments) performed using the digital account 204, login data (e.g., login attempts, password changes, etc.), account verification activity, and so forth. Accordingly, the fraud-risk tiering system 104 continuously assesses risk of fraud and provides for active evaluation of accounts utilizing various forms of data throughout the existence of the digital account 204.

As also shown in FIG. 2, in response to determining the risk tier 216, the fraud-risk tiering system 104 authorizes or deactivates access to one or more features 218 of a mobile application via the digital account 204. In some instances, for example, in response to determining the risk tier 216 for the digital account 204 to be below a predetermined threshold, the fraud-risk tiering system 104 deactivates or restricts access to one or more features 218 that would otherwise be accessible to the digital account 204. Also, in some instances, in response to determining the risk tier 216 for the digital account 204 to be above a predetermined threshold, the fraud-risk tiering system 104 activates or grants access to one or more features 218 via the digital account 204.

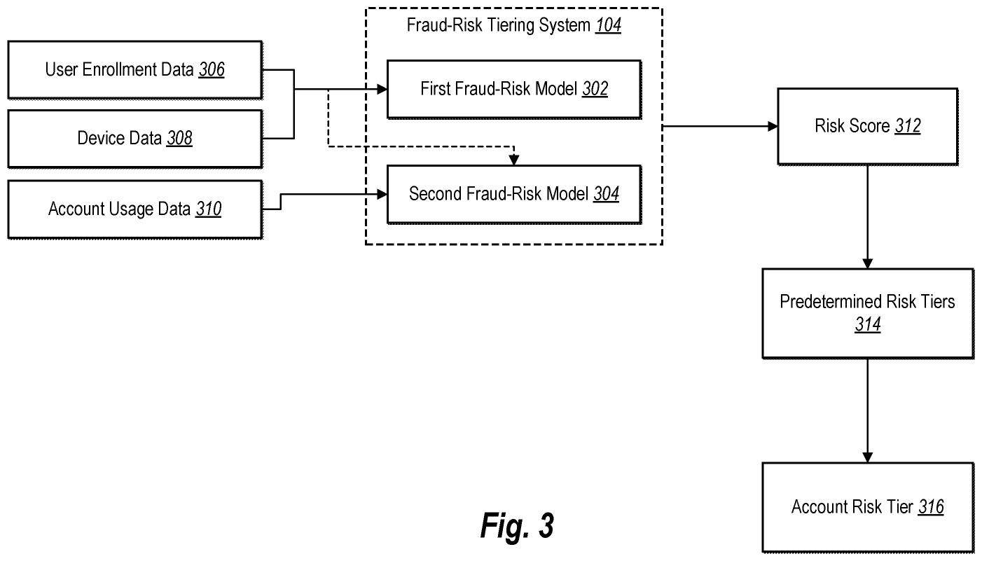

As mentioned previously, the fraud-risk tiering system 104 can utilize multiple intelligently trained fraud-risk models to determine (i.e., assign) risk tiers to digital accounts. For example, FIG. 3 illustrates the fraud-risk tiering system 104 utilizing a first fraud-risk model 302 and a second fraud-risk model 304 to determine an account risk tier 316 for a digital account. In particular, FIG. 3 shows the fraud-risk tiering system 104 utilizing the first fraud-risk model 302 and the second fraud-risk model 304 as independently trained fraud-risk models to determine a risk score 312 for a digital account based on consideration of various types of data.

For instance, the first fraud-risk model determines the risk score 312 based at least on user enrollment data 306 and device data 308. For example, the fraud-risk tiering system 104 can utilize the first fraud-risk model 302 to determine an initial value of the risk score 312 in response to a request to create a new digital account. Then, in response to determining the initial value of the risk score 312, the fraud-risk tiering system 104 selects an account risk tier 316 from a plurality of predetermined risk tiers 314, based on the risk score 312 as an initial risk score.

As further illustrated in FIG. 3, the fraud-risk tiering system 104 utilizes a second fraud-risk model 304 to determine updated values of the risk score 312 as additional data is received. For instance, the second fraud-risk model 304 determines the risk score 312 based at least on account usage data 310 and, in some cases, also based on user enrollment data 306 and/or device data 308. In response to determining an updated value of the risk score 312, the fraud-risk tiering system 104 selects the account risk tier 316 as an updated account risk tier from a plurality of predetermined risk tiers 314, based on the updated value of the risk score 312.

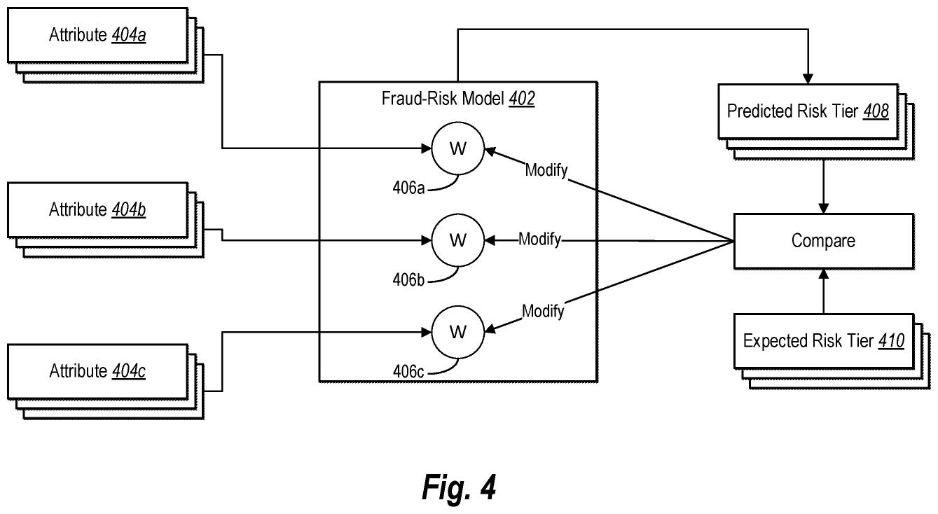

As mentioned previously, the fraud-risk tiering system 104 can utilize one or more intelligently trained fraud-risk models to determine risk tiers for digital accounts that accurately represent the likelihood that each account will perpetuate a fraud-related incident. For example, FIG. 4 illustrates the fraud-risk tiering system 104 training a fraud-risk model 402 based on various attributes 404a, 404b, and 404c of a population of digital accounts. Specifically, in one or more embodiments, the fraud-risk tiering system 104 trains the fraud-risk model 402 utilizing a sample population of digital accounts having known attributes and known fraud rates (i.e., wherein a portion of the digital accounts in the sample population have perpetuated one or more incidents of fraud or other security events).

As illustrated in FIG. 4, the fraud-risk tiering system 104 applies weights 406a, 406b, and 406c to attributes 404a, 404b, and 404c, respectively, corresponding to a given digital account of the sample population to determine a predicted risk tier 408. In response, the fraud-risk tiering system 104 compares the predicted risk tier 408 with an expected risk tier 410 for the given digital account. The fraud-risk tiering system 104 determines the expected risk tier 410 for each given digital account based on known historical data. For example, a given digital account may be designated as belonging to a relatively high-risk tier if that account has been the subject of a fraudulent event or other security-related incident, whereas a given digital account may be designated as belonging to a relatively low-risk tier if no such incidents have occurred. Accordingly, in the implementation shown, the fraud-risk tiering system 104 compares the predicted risk tier 408, predicted by the fraud-risk model 402 based on attributes 404a-404c, with the expected risk tier 410, designated according to actual historical data for the given account, and adjusts (i.e., modifies) one or more of the weights 406a-406c to train the fraud-risk model 402.

Moreover, the fraud-risk tiering system 104 can determine expected risk tiers 410 for a sample population by a number of methods in consideration of historical data with respect to incidents of fraud associated with the sample population of digital accounts. In some embodiments, for example, the fraud-risk tiering system 104 utilizes logistic regression or other types of statistical analysis to utilize historical data for determining expected risk tiers 410 for a sample population of digital accounts.

Furthermore, as mentioned above, in certain embodiments, the fraud-risk tiering system 104 considers various attributes for predicting risk tiers for digital accounts. For example, Table 1 below includes multiple examples of account, user (i.e., member), and device attributes usable by the fraud-risk tiering system 104 for evaluation fraud-risk of digital accounts according to one or more embodiments. Also, Table 1 indicates which type of weight (positive or negative) is generally assigned to each given attribute. As discussed above in relation to FIG. 4, in certain embodiments, the fraud-risk tiering system 104 assign/train specific weights (i.e., numerical values) for each attribute considered in order to intelligently and accurately predict risk tiers for digital accounts.

TABLE 1

| Attribute | Description | Indicator |
|---|---|---|
| Mobile IP | IP used at enrollment address is from a mobile phone in | Strong |
| | the US | Positive |
| Address Low Risk | Member address at enrollment identified as low risk | Positive |
| Phone Address Match | Phone number correlates to input address | Positive |
| Phone Address Partial | Address associated with phone only partially matches | Positive |
| Match | input address | |
| Phone First Name | First name correlates to phone | Positive |
| Match | | |
| Phone Last Name | Last name correlates to phone | Positive |
| Match | | |
| Aged Email | Email account used at enrollment is over 6 months old | Positive |
| New Phone | Phone line in service less than 30 days | Negative |
| VOIP Phone | Phone is non-fixed voice-over-IP phone | Negative |
| Email High Risk | Email address identified as high risk | Negative |
| Phone High Risk | Phone number identified as high risk | Negative |
| Address High Risk | Member address identified as high risk | Negative |
| Email Auto Generated | Email address was auto-generated | Negative |
| IP Location to Address | IP geolocation of device at enrollment is more than 100 | Negative |
| High Distance | miles from member address at enrollment | |
| Inactive Phone | Phone service discontinued or not actively used | Negative |
| Not Major Carrier | Phone is not associated with a major US carrier | Negative |
| New Email | Email identified as new at enrollment (not previously | Negative |
| | seen online) | |
| IP Velocity | IP address of device associated with multiple enrollment | Strong |
| | attempts in recent period | Negative |
| VPN or Proxy | IP used at enrollment is a Virtual Private Network or | Strong |
| | proxy IP | Negative |
| Young Email Domain | Email domain is less than 180 days old | Strong |
| | | Negative |
| Not US Time Zone | Latest login by member was from a non-US time zone | Negative |
| Number of Logins in | Number of times the member logged into account in | Negative |
| Prior 48 Hours | prior 24 hours (weight increases with count) | |
| Members Associated | Number of unique members associated with device(s) | Negative |
| With Same Device | used to access account (weight increases with count) | |
| Device Count By | Number of devices used by individual member in prior | Negative |
| Member | 30 days (weight increases with count) | |
| Closed Members | Number of unique closed (i.e., cancelled) members | Strong |
| Associated With Same | associated with any device used by member (higher | Negative |
| Device | weight given to account closures related to fraud) | |
| Direct Deposit Used | Whether the member has received a direct deposit from | Strong |
| | employer | Positive |
| Card Activated | Whether the member has activated a debit card for the | Strong |
| | account | Negative |
| Overdraft Eligible | Whether the member is eligible for overdrafts | Strong |
| | | Positive |
| Negative Checking | Count of negative balances on checking account in past | Positive |
| Account Balance Days | 30 days | |
| in Last 30 Days | | |
| Negative Credit | Count of negative balances on credit account in past 30 | Negative |
| Account Balance in | days | |
| Last 30 Days | | |
| Check(s) Returned | Checks returned in recent history | Strong |
| | | Negative |

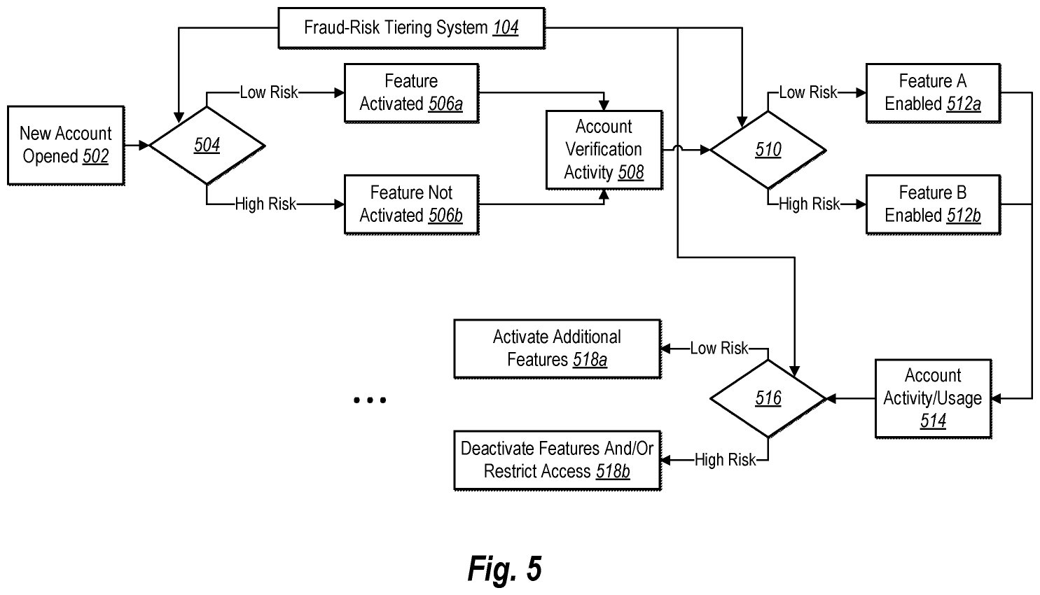

As mentioned previously, the fraud-risk tiering system 104 can monitor and evaluate digital accounts at account creation and on an ongoing basis to prevent incidents of fraud and other breaches of security while enabling intelligent offering of account features to digital accounts according to their respectively determined risk tiers. For example, FIG. 5 illustrates a process flowchart of an example account experience according to one or more embodiments. Specifically, FIG. 5 shows various decision points throughout a life of a digital account at which the fraud-risk tiering system 104 predicts a risk tier (in the illustrated case, “High Risk” or “Low Risk”) and implements action according to the predicted risk tier for the digital account.

As shown in FIG. 5, when a new account is opened at 502 (i.e., a request for account creation is received, as discussed above in relation to FIGS. 2-3), the fraud-risk tiering system 104 determines an initial risk tier for the new account at 504. If the fraud-risk tiering system 104 determines that the initial risk tier is Low Risk, the fraud-risk tiering system 104 activates one or more features on the digital account at 506a, such as, for example, pre-approved spending on credit and/or the ability to make peer-to-peer (P2P) transfers of funds utilizing the digital account. If the fraud-risk tiering system 104 determines that the initial risk tier is High Risk, the aforementioned one or more features are not activated at 506b.

After a period of time (e.g., 7 days), the fraud-risk tiering system 104 utilizes additional data, such as account verification activity 508, to determine an updated risk tier at 510. For instance, if the user (i.e., the owner of the account) has verified their account by activating a debit card sent to the physical address provided upon account creation at 502 (or by other means), the fraud-risk tiering system 104 may determine the updated risk tier to be Low Risk. However, in some cases where the risk tier was previously determined to be High Risk, the fraud-risk tiering system 104 may determine that the updated risk tier is still High Risk due to other weighted attributes.

As shown in FIG. 5, if the fraud-risk tiering system 104 determines at 510 that the updated risk tier is Low Risk, the fraud-risk tiering system 104 enables (i.e., activates) a first feature (Feature A) at 512a. If the fraud-risk tiering system 104 determines at 510 that the updated risk tier is High Risk, the fraud-risk tiering system 104 enables (i.e., activates) a second feature (Feature B) at 512b. For example, Feature A may include spending limits or other incentives that are relatively greater than those offered as part of Feature B. Accordingly, the fraud-risk tiering system 104 can manage account features according to risk tiers to reduce fraud and/or alleviate consequences thereof while still allowing higher risk accounts access to some features.

After an additional period of time allowing for account activity/usage 514 (e.g., at a set time after account creation, intermittently, or any time account activity/usage is detected), the fraud-risk tiering system 104 utilizes usage data to again determine an updated risk tier at 516. In some embodiments, for example, account activity/usage 514 includes login data, additional account verification data, transaction data from purchases and/or payments, and so forth. If the fraud-risk tiering system 104 determines at 516 that the updated risk tier for the digital account is Low Risk, the fraud-risk tiering system 104 activates additional features at 518a. However, if the fraud-risk tiering system 104 determines at 516 that the updated risk tier is High Risk, the fraud-risk tiering system 104 deactivates features (e.g., disables peer-to-peer transactions) and/or restricts access to the digital account at 518b.

Accordingly, in certain embodiments, the fraud-risk tiering system 104 determines an initial risk tier at account creation, then determine updated risk tiers on an ongoing basis as additional data (or a lack thereof) is received and processed. Generally, in some embodiments, if a risk tier for a digital account is determined to change from a high-risk tier to a relatively low-risk tier, additional features and incentives will be offered to the account user. Conversely, if a risk tier for a digital account is determined to change from a low-risk tier to a relatively high-risk tier, restriction of account features or incentives are implemented and, in some cases, account suspension may be effectuated to prevent fraud and other security-related incidents.

As mentioned previously, the fraud-risk tiering system 104 can predetermine a plurality of risk tiers to represent a sample population of digital accounts for training one or more fraud-risk tiering models. For example, Table 2 below shows example risk tiers determined for a sample population according to one or more embodiments. In particular, Table 2 shows an exemplary sorting of accounts into risk tiers according to attribute data (such as described in Table 1 above) and at particular times within the life of each digital account within the sample populations. Indeed, as shown in Table 2 below, predetermined risk tiers can be shown to accurately represent the statistical probability of fraud within a sample population and thus can accurately predict fraud of newly opened accounts.

TABLE 2

| | | | | | | |
|---|---|---|---|---|---|---|
| | Account | | Direct | Card | Incentive | Incentive |
| Risk Tier | Distribution | Fraud Rate | Deposit | Activation | Received | Fraud Rate |

Day 0

| | | | | | | |
|---|---|---|---|---|---|---|
| Low Risk | 84.9% | 1.9% | 15.6% | 47.1% | 71.0% | 1.3% |
| High Risk | 15.1% | 27.1% | 6.7% | 24.3% | 29.0% | 47.4% |

Day 7

| | | | | | | |
|---|---|---|---|---|---|---|
| Low Risk | 89.5% | 1.9% | 15.2% | 45.9% | 73.5% | 1.5% |
| High Risk | 10.5% | 34.3% | 6.7% | 24.3% | 26.5% | 51.2% |

Day 30

| | | | | | | |
|---|---|---|---|---|---|---|
| Low Risk | 93.6% | 1.9% | 15.0% | 45.1% | 81.0% | 1.8% |
| High Risk | 6.4% | 44.1% | 4.5% | 21.4% | 19.0% | 57.7% |

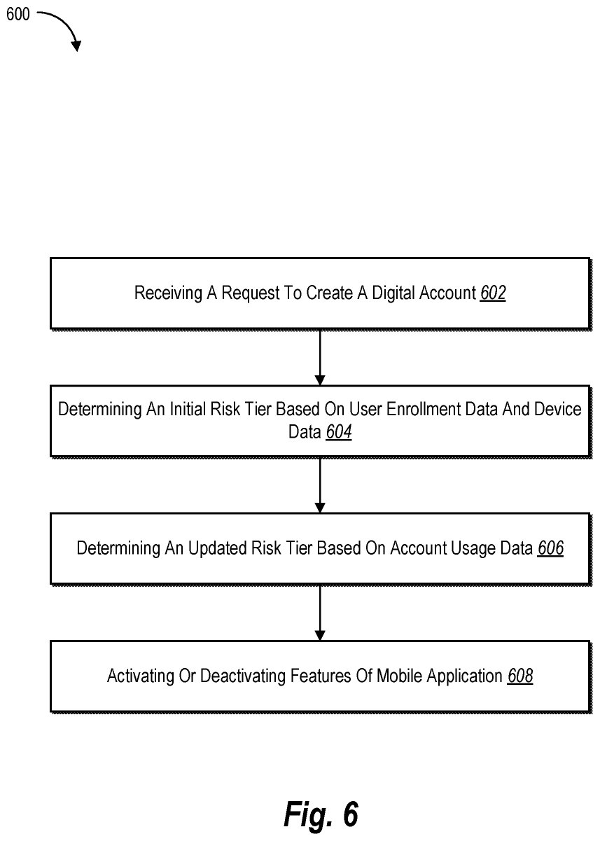

FIGS. 1-5, the corresponding text, and the examples provide a number of different methods, systems, devices, and non-transitory computer-readable media of the fraud-risk tiering system 104. In addition to the foregoing, one or more embodiments can also be described in terms of flowcharts comprising acts for accomplishing a particular result, as shown in FIG. 6. FIG. 6 may be performed with more or fewer acts. Further, the acts may be performed in differing orders. Additionally, the acts described herein may be repeated or performed in parallel with one another or parallel with different instances of the same or similar acts.

While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer-readable medium can comprise instructions that, when executed by one or more processors, cause a computing device to perform the acts of FIG. 6. In some embodiments, a system can perform the acts of FIG. 6. Additionally, the acts described herein may be repeated or performed in parallel with one another or in parallel with different instances of the same or other similar acts.

As shown, FIG. 6 illustrates an example series of acts 600 for predicting whether a digital account on a digital financial network is fraudulent or likely to perpetuate or attempt fraudulent activity on the digital financial network. The series of acts 600 can include an act 602 for receiving a request to create a digital account. In particular, the act 602 can include receiving, from a user computing device associated with a user, a request to create a digital account, the request comprising user enrollment data and device data associated with the user computing device. Furthermore, in some embodiments, the act 602 can also include creating, in response to receiving the request, the digital account.

As also shown in FIG. 6, the series of acts 600 can include an act 604 for determining an initial risk tier based on user enrollment data and device data. In particular, the act 604 can include determining an initial risk tier for the digital account from a plurality of risk tiers based on attributes corresponding to the user enrollment data and the device data. Moreover, in some embodiments, the act 604 includes comparing a user address from the user enrollment data with a geospatial location from the device data. In one or more embodiments, the plurality of risk tiers comprises a low-risk tier corresponding to a relatively lower likelihood of fraudulent activity and a high-risk tier corresponding to a relatively higher likelihood of fraudulent activity.

In addition, as shown in FIG. 6, the series of acts 600 can include an act 606 for determining an updated risk tier based on account usage data. In particular, the act 606 can include identifying account usage data corresponding to the digital account and determining an updated risk tier for the digital account based on the account usage data. In some embodiments, the account usage data comprises at least one of transaction history, login history, or account verification activity.

Moreover, in some embodiments the acts 604 and 606 include determining the initial risk tier utilizing a first fraud-risk model and determining the updated risk tier utilizing a second fraud-risk model, respectively. Also, in one or more embodiments, the acts 604 or 606 include determining the initial risk tier or determining the updated risk tier utilizing a machine-learning model, respectively.

Also, as shown in FIG. 6, the series of acts 600 can include an act 608 for activating or deactivating features of a mobile application. In particular, the act 608 can include authorizing access to one or more features of a mobile application via the digital account in response to determining the initial risk tier or the updated risk tier for the digital account to be the low-risk tier. Also, in some embodiments, the act 608 can include restricting access to one or more features of the digital account in response to determining the initial risk tier or the updated risk tier for the digital account to be the high-risk tier.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 7 illustrates a block diagram of an example computing device 700 that may be configured to perform one or more of the processes described above. In one or more embodiments, the computing device 700 may be a mobile device (e.g., a mobile telephone, a smartphone, a PDA, a tablet, a laptop, a camera, a tracker, a watch, a wearable device, etc.). In some embodiments, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output interfaces 708 (or “I/O interfaces 708”), and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other embodiments. Furthermore, in certain embodiments, the computing device 700 includes fewer components than those shown in FIG. 7. Components of the computing device 700 shown in FIG. 7 will now be described in additional detail.

In particular embodiments, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, the storage device 706 can include a non-transitory storage medium described above. The storage device 706 may include a hard disk drive (HDD), flash memory, a Universal Serial Bus (USB) drive or a combination these or other storage devices.

As shown, the computing device 700 includes one or more I/O interfaces 708, which are provided to allow a user to provide input to (such as user strokes), receive output from, and otherwise transfer data to and from the computing device 700. These I/O interfaces 708 may include a mouse, keypad or a keyboard, a touch screen, camera, optical scanner, network interface, modem, other known I/O devices or a combination of such I/O interfaces 708. The touch screen may be activated with a stylus or a finger.

The I/O interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can include hardware, software, or both that connects components of computing device 700 to each other.

FIG. 8 illustrates an example network environment 800 of the fraud-risk tiering system 104. The network environment 800 includes a client device 806 (e.g., client device 106), a fraud-risk tiering system 104, and a third-party system 808 (e.g., the third-party system(s) 110) connected to each other by a network 804. Although FIG. 8 illustrates a particular arrangement of the client device 806, the fraud-risk tiering system 104, the third-party system 808, and the network 804, this disclosure contemplates any suitable arrangement of client device 806, the fraud-risk tiering system 104, the third-party system 808, and the network 804. As an example, and not by way of limitation, two or more of client device 806, the fraud-risk tiering system 104, and the third-party system 808 communicate directly, bypassing network 804. As another example, two or more of client device 806, the fraud-risk tiering system 104, and the third-party system 808 may be physically or logically co-located with each other in whole or in part.

Moreover, although FIG. 8 illustrates a particular number of client devices 806, fraud-risk tiering systems 104, third-party systems 808, and networks 804, this disclosure contemplates any suitable number of client devices 806, fraud-risk tiering system 104, third-party systems 808, and networks 804. As an example, and not by way of limitation, network environment 800 may include multiple client devices 806, fraud-risk tiering system 104, third-party systems 808, and/or networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, the fraud-risk tiering system 104, and third-party system 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at the client device 806 to access network 804. A client device 806 may enable its user to communicate with other users at other client devices 806.

In particular embodiments, the client device 806 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, fraud-risk tiering system 104 may be a network-addressable computing system that can interface between two or more computing networks or servers associated with different entities such as financial institutions (e.g., banks, credit processing systems, ATM systems, or others). In particular, the fraud-risk tiering system 104 can send and receive network communications (e.g., via the network 804) to link the third-party system 808. For example, the fraud-risk tiering system 104 may receive authentication credentials from a user to link a third-party system 808 such as an online banking system to link an online bank account, credit account, debit account, or other financial account to a user account within the fraud-risk tiering system 104. The fraud-risk tiering system 104 can subsequently communicate with the third-party system 808 to detect or identify balances, transactions, withdrawal, transfers, deposits, credits, debits, or other transaction types associated with the third-party system 808. The fraud-risk tiering system 104 can further provide the aforementioned or other financial information associated with the third-party system 808 for display via the client device 806. In some cases, the fraud-risk tiering system 104 links more than one third-party system 808, receiving account information for accounts associated with each respective third-party system 808 and performing operations or transactions between the different systems via authorized network connections.

In particular embodiments, the fraud-risk tiering system 104 may interface between an online banking system and a credit processing system via the network 804. For example, the fraud-risk tiering system 104 can provide access to a bank account of a third-party system 808 and linked to a user account within the fraud-risk tiering system 104. Indeed, the fraud-risk tiering system 104 can facilitate access to, and transactions to and from, the bank account of the third-party system 808 via a client application of the fraud-risk tiering system 104 on the client device 806. The fraud-risk tiering system 104 can also communicate with a credit processing system, an ATM system, and/or other financial systems (e.g., via the network 804) to authorize and process credit charges to a credit account, perform ATM transactions, perform transfers (or other transactions) between user accounts or across accounts of different third-party systems 808, and to present corresponding information via the client device 806.

In particular embodiments, the fraud-risk tiering system 104 includes a model (e.g., a machine learning model) for approving or denying transactions. For example, the fraud-risk tiering system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the fraud-risk tiering system 104 and/or one or more third-party systems 808), the fraud-risk tiering system 104 can utilize the transaction approval machine learning model to generate a prediction (e.g., a percentage likelihood) of approval or denial of a transaction (e.g., a withdrawal, a transfer, or a purchase) across one or more networked systems.

The fraud-risk tiering system 104 may be accessed by the other components of network environment 800 either directly or via network 804. In particular embodiments, the fraud-risk tiering system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the fraud-risk tiering system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or an fraud-risk tiering system 104 to manage, retrieve, modify, add, or delete, the information stored in data store.

In particular embodiments, the fraud-risk tiering system 104 may provide users with the ability to take actions on various types of items or objects, supported by the fraud-risk tiering system 104. As an example, and not by way of limitation, the items and objects may include financial institution networks for banking, credit processing, or other transactions, to which users of the fraud-risk tiering system 104 may belong, computer-based applications that a user may use, transactions, interactions that a user may perform, or other suitable items or objects. A user may interact with anything that is capable of being represented in the fraud-risk tiering system 104 or by an external system of a third-party system, which is separate from fraud-risk tiering system 104 and coupled to the fraud-risk tiering system 104 via a network 804.

In particular embodiments, the fraud-risk tiering system 104 may be capable of linking a variety of entities. As an example, and not by way of limitation, the fraud-risk tiering system 104 may enable users to interact with each other or other entities, or to allow users to interact with these entities through an application programming interfaces (“API”) or other communication channels.

In particular embodiments, the fraud-risk tiering system 104 may include a variety of servers, sub-systems, programs, modules, logs, and data stores. In particular embodiments, the fraud-risk tiering system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The fraud-risk tiering system 104 may also include suitable components such as network interfaces, security mechanisms, load balancers, failover servers, management-and-network-operations consoles, other suitable components, or any suitable combination thereof. In particular embodiments, the fraud-risk tiering system 104 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the fraud-risk tiering system 104 and one or more client devices 806. An action logger may be used to receive communications from a web server about a user's actions on or off the fraud-risk tiering system 104. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of the fraud-risk tiering system 104. A privacy setting of a user determines how particular information associated with a user can be shared. The authorization server may allow users to opt in to or opt out of having their actions logged by the fraud-risk tiering system 104 or shared with other systems, such as, for example, by setting appropriate privacy settings. Third-party-content-object stores may be used to store content objects received from third parties. Location stores may be used for storing location information received from client devices 806 associated with users.

In addition, the third-party system 808 can include one or more computing devices, servers, or sub-networks associated with internet banks, central banks, commercial banks, retail banks, credit processors, credit issuers, ATM systems, credit unions, loan associates, brokerage firms, linked to the fraud-risk tiering system 104 via the network 804. A third-party system 808 can communicate with the fraud-risk tiering system 104 to provide financial information pertaining to balances, transactions, and other information, whereupon the fraud-risk tiering system 104 can provide corresponding information for display via the client device 806. In particular embodiments, a third-party system 808 communicates with the fraud-risk tiering system 104 to update account balances, transaction histories, credit usage, and other internal information of the fraud-risk tiering system 104 and/or the third-party system 808 based on user interaction with the fraud-risk tiering system 104 (e.g., via the client device 806). Indeed, the fraud-risk tiering system 104 can synchronize information across one or more third-party systems 808 to reflect accurate account information (e.g., balances, transactions, etc.) across one or more networked systems, including instances where a transaction (e.g., a transfer) from one third-party system 808 affects another third-party system 808.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a user computing device associated with a user, a request to create a digital account, the request comprising user enrollment data and device data associated with the user computing device;
creating, in response to receiving the request, the digital account;
determining an initial risk tier for the digital account from a plurality of risk tiers based on attributes corresponding to the user enrollment data and the device data;
identifying account usage data corresponding to the digital account; and
determining an updated risk tier for the digital account based on the account usage data.

2. The computer-implemented method of claim 1, wherein determining the initial risk tier for the digital account comprises comparing a user address from the user enrollment data with a geospatial location from the device data.

3. The computer-implemented method of claim 1, further comprising:
determining the initial risk tier utilizing a first fraud-risk model; and
determining the updated risk tier utilizing a second fraud-risk model.

4. The computer-implemented method of claim 1, wherein the account usage data comprises at least one of transaction history, login history, or account verification activity.

5. The computer-implemented method of claim 1, wherein the plurality of risk tiers comprises a low-risk tier corresponding to a relatively lower likelihood of fraudulent activity and a high-risk tier corresponding to a relatively higher likelihood of fraudulent activity.

6. The computer-implemented method of claim 5, further comprising:
determining the initial risk tier or the updated risk tier for the digital account to be the low-risk tier; and
in response, authorizing access to one or more features of a mobile application via the digital account.

7. The computer-implemented method of claim 5, further comprising:
determining the initial risk tier or the updated risk tier for the digital account to be the high-risk tier; and
in response, restricting access to one or more features of the digital account.

8. The computer-implemented method of claim 1, further comprising determining the initial risk tier or determining the updated risk tier utilizing a machine-learning model.

9. A non-transitory computer-readable medium storing executable instructions that, when executed by at least one processor, cause a computing device to:
receive, from a user computing device associated with a user, a request to create a digital account, the request comprising user enrollment data and device data associated with the user computing device;
create, in response to receiving the request, the digital account;
determine an initial risk tier for the digital account from a plurality of risk tiers based on attributes corresponding to the user enrollment data and the device data;
identify account usage data corresponding to the digital account; and
determine an updated risk tier for the digital account based on the account usage data.

10. The non-transitory computer-readable medium of claim 9, further comprising instructions that, when executed by the at least one processor, cause the computing device to determine the initial risk tier for the digital account by comparing a user address from the user enrollment data with a geospatial location from the device data.

11. The non-transitory computer-readable medium of claim 9, further comprising instructions that, when executed by the at least one processor, cause the computing device to:
determine the initial risk tier utilizing a first fraud-risk model; and
determine the updated risk tier utilizing a second fraud-risk model.

12. The non-transitory computer-readable medium of claim 9, wherein the plurality of risk tiers comprises a low-risk tier corresponding to a relatively lower likelihood of fraudulent activity and a high-risk tier corresponding to a relatively higher likelihood of fraudulent activity.

13. The non-transitory computer-readable medium of claim 12, further comprising instructions that, when executed by the at least one processor, cause the computing device to:
determine the initial risk tier or the updated risk tier for the digital account to be the low-risk tier; and
in response, authorize access to one or more features of a mobile application via the digital account.

14. The non-transitory computer-readable medium of claim 12, further comprising instructions that, when executed by the at least one processor, cause the computing device to:
determine the initial risk tier or the updated risk tier for the digital account to be the high-risk tier; and
in response, restrict access to one or more features of the digital account.

15. A system comprising:
one or more memory devices comprising a plurality of risk tiers; and
one or more processors configured to cause the system to:
receive, from a user computing device associated with a user, a request to create a digital account, the request comprising user enrollment data and device data associated with the user computing device;
create, in response to receiving the request, the digital account;
determine an initial risk tier for the digital account from the plurality of risk tiers based on attributes corresponding to the user enrollment data and the device data;
identify account usage data corresponding to the digital account; and
determine an updated risk tier for the digital account based on the account usage data.

16. The system of claim 15, wherein determining the initial risk tier for the digital account comprises comparing a user address from the user enrollment data with a geospatial location from the device data.

17. The system of claim 15, wherein the one or more processors are further configured to cause the system to:
determine the initial risk tier utilizing a first fraud-risk model; and
determine the updated risk tier utilizing a second fraud-risk model.

18. The system of claim 15, wherein the account usage data comprises at least one of transaction history, login history, or account verification activity.

19. The system of claim 15, wherein the plurality of risk tiers comprises a low-risk tier corresponding to a relatively lower likelihood of fraudulent activity and a high-risk tier corresponding to a relatively higher likelihood of fraudulent activity.

20. The system of claim 15, wherein the one or more processors are further configured to cause the system to determine the initial risk tier or the updated risk tier utilizing a machine-learning model.
